(19) United States
(12) Patent Application Publication
(10) Pub. No.: US 2002/0082848 A1
(43) Pub. Date: Jun. 27, 2002

(54) Flight information display system and method

(76) Inventors: Eric Hansen, Thunder Bay (CA); Scott McFadden, Thunder Bay (CA); Ed Schmidtke, Thunder Bay (CA)

Correspondence Address: DAVID P. GORDON, 65 Woods End Road, Stamford, CT, 06905, US

(21) Appl. No.: 09/745,100

(22) Filed: Dec. 22, 2000

(51) Int. Cl. G06F 17/60

(52) U.S. Cl. 705/1

(57) ABSTRACT

The present invention provides a system and method for providing flight information data to an airport. A flight information provider collects airline-specific flight information data from several airlines. The airline-specific flight information is then processed by the flight information provider to generate airport-specific flight information containing flight information for flights arriving at and departing from each airport. Web pages are then generated for each airport containing the airport-specific flight information for that airport. The web pages are then transmitted to the airports for display on monitors in the airports.

### FIELD OF THE INVENTION

The invention relates to systems and methods for displaying air travel flight information and in particular to a web-based flight information display system and method.

### BACKGROUND OF THE INVENTION

In most airports around the world, monitors are placed throughout public areas for displaying flight information for viewing by passengers and other visitors. Such information can include for a particular flight, a flight number, airline, time of arrival or time of departure, and gate number. This information is provided to the public so as to facilitate use of air flight services, for example so that a visitor can ensure that a flight is departing or arriving on time, or determine the gate at which passengers will be boarding or disembarking from a flight.

As noted above, this information is communicated to the airport's visitors using monitors. In a typical system, these monitors are controlled by a central computer server located within the airport which creates the pages to be displayed on the monitors. The information contained in these pages is downloaded by the computer server from airline flight reservation systems to which the server is connected through private telecommunication connections. The information is then processed by the server, display pages are generated, and the pages are transmitted to the monitors.

There is significant expense incurred by both airports and airlines in setting up and maintaining such a system of communicating flight information to airport visitors.

Almost all airports service a number of airlines. Accordingly, a separate private telecommunication connection must be established and maintained with each of these airlines for receipt of flight data from the airlines. Additional information technology expense is incurred in ensuring that flight information is properly received from each airline, and is processed for display on the monitors. Significantly, there is at present no direct means for an airport to recover any of these costs.

Significant costs are also incurred by airlines who supply this flight information to the airports. For privacy and security purposes, the only flight information typically made available by a given airline to a particular airport, is limited to information relating to flights arriving at, or departing from, that airport. Thus, each airline must filter its own flight information to determine which information should be transmitted to each airport. Further, to provide this information to each airport, the airline must establish a private telecommunication link with the airport. Because a given airline may be serviced by as many as 100 or even 1,000 airports, the expenses associated with establishing and maintaining these private telecommunication links and filtering flight information for each of these airports can be enormous.

### SUMMARY OF THE INVENTION

In a broad aspect, the present invention provides a method of providing airport-specific flight information data to a client. This method involves collecting from each of a number of airlines, airline-specific flight information data for flights operated by the airline, wherein the airline-specific flight information data from at least one of the number of airlines includes flight information for flights not departing from or arriving at a particular airport; identifying in the airline-specific flight information data collected from each of the airlines, airport-specific flight information data consisting of flight information for flights departing from or arriving at the particular airport; and providing the airport-specific flight information data to the client.

In another aspect, the invention provides a host system for collecting, processing and transmitting flight information data. This host system comprises a host processor connectable to each of a plurality of airline processors each operated by an airline, and a client processor. The host processor is operable to execute an application causing the host processor to: collect from each of the airline processors, airline-specific flight information data for flights operated by the airline operating the airline processor, wherein the airline-specific flight information data from at least one of the plurality of airline processors includes flight information for flights not departing from or arriving at a particular airport; receive a request from the client processor for airport-specific flight information for the particular airport; identify in the airline-specific flight information data collected from each of the airline processors, airport-specific flight information data consisting of flight information for flights departing from or arriving at the particular airport; and transmit the airport-specific flight information data to the client processor.

In a further aspect, the invention provides a method in a client computer of providing reliable access to a host computer, both the client computer and the host computer being connectable to a web-based computer network. This method comprises defining a first and a second web address for the host computer; attempting to access data from the host computer using the first web address; and upon failure to access data from the host computer using the first web address within a first predetermined period of time, attempting to access data from the host computer using the second web address.

In a still further aspect, the present invention provides a method in a computer system comprising a processor connected to a monitor, of displaying airport-specific flight information data. This method comprises the steps of (a) establishing a network connection with a flight information provider; b) requesting from the flight information provider, airport-specific flight information data comprising flight information for flights departing from or arriving at an airport; (c) receiving from the flight information provider, a web page containing the airport-specific flight information data; and (d) displaying the web page. The predetermined first and second network addresses are defined for the flight information provider, step (a) is first attempted using the first network address, and if step (a) is not completed within a first predetermined time period, step (a) is attempted using the second network address.

Advantageously, the present invention provides a highly reliable method and system of providing flight information which results in a cost savings for both airports and airlines. First, each airport only needs to establish a single connection, namely with the host computer operated by a flight information provider, for receipt of all relevant flight information, instead of needing to establish a separate connection with each airline it services. Additionally, the capital and ongoing information technology expenses are reduced for the airport since the information is already processed by the flight information provider for immediate display on the airport's terminals, and this information would be automatically updated. Finally, instead of a flight information system being an accepted expense for an airport, the invention offers an opportunity for an airport's flight information system to be a revenue generator through sales of advertisements on the flight information display pages.

Airlines also benefit. As the collection of information is centralized by the flight information provider, the number of telecommunication connections each airline requires for disseminating its flight information is greatly reduced since a separate connection with each airport servicing the airline will no longer be necessary. Further, since the flight information provider is processing each airline's flight information so as to transmit to a given airport only the information relevant to the flights arriving and departing from that airport, the airline does not need to filter its information as it would if it were sending information directly to the airport.

### BRIEF DESCRIPTION OF THE DRAWINGS

Embodiments of the invention will now be described with reference to the attached drawings in which:

FIG. 1 is a block diagram of a computer system network for implementing a method in accordance with an embodiment of the present invention;

FIG. 2 is a flow chart describing a method of providing flight information in accordance with an embodiment of the present invention;

FIG. 3 is a data structure for airline-specific flight information data received by a flight information provider processor in accordance with the method of FIG. 2;

FIG. 4 is a data structure for airport-specific flight information data generated by the flight information provider processor in accordance with the method of FIG. 2;

FIG. 5 is a sample web page generated by the flight information provider processor in accordance with the method of FIG. 2; and

FIG. 6 is a flow chart describing a method of providing a highly reliable connection across a web-based network in accordance with an embodiment of the present invention.

### DETAILED DESCRIPTION OF THE PREFERRED EMBODIMENTS

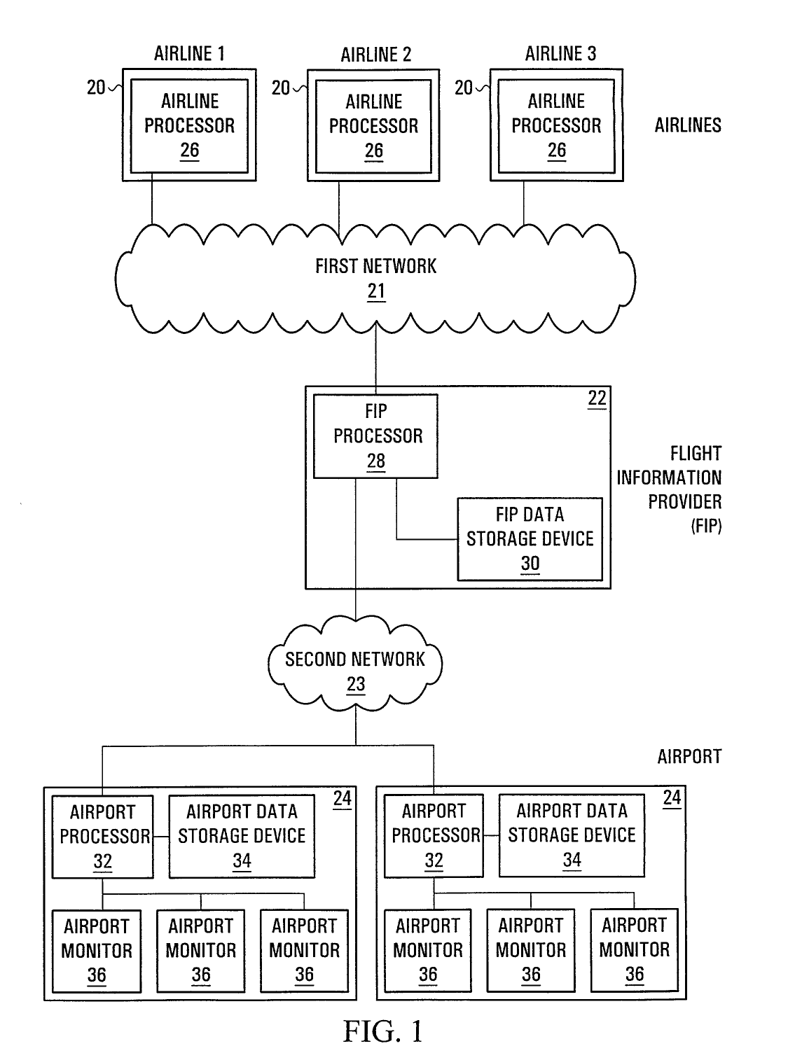

FIG. 1 is a block diagram of an exemplary computer system network which may be used to implement a method in accordance with an embodiment of the present invention. The computer system network generally consists of a number of airlines 20, connected through a first network 21 to a flight information provider (FIP) 22, which in turn is connected through a second network 23 to a number of airports 24. Each airline 20 operates an airline processor 26. The FIP 22 operates an FIP processor 28 connected to an FIP data storage device 30. Finally, each airport 24 operates an airport processor 32 which is connected to each of an airport data storage device 34, and one or more airport monitors 36. The function and interconnection of the various elements of the exemplary computer system network will be described in greater detail below in describing a method of the present invention.

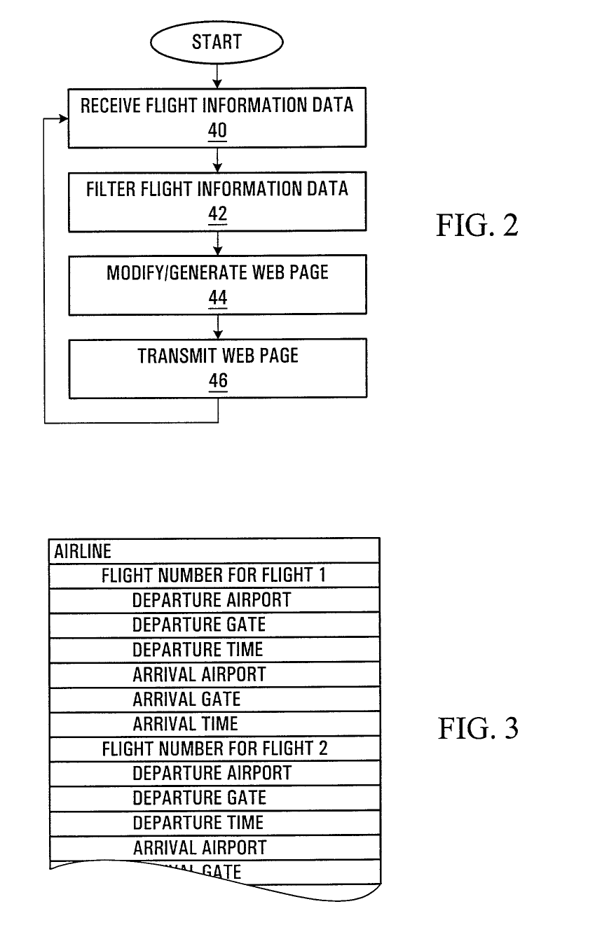

FIG. 2 is a flow chart showing the basic steps performed by the FIP processor 28 in implementing a method of the present invention.

First, airline-specific flight information data (FID) relating to flights operated by an airline 20 is transmitted by the airline's airline processor 26 and received by the FIP processor 28 (step 40). The airline-specific FID is generated by the airline processor 26 using any one of, or a combination of several sources of flight information. Such sources of flight information may include schedules prepared by the airline 20 operating the airline processor 26 in planning flights, updates and changes made by airline personnel or other computer systems, and continuous transponder data received from airplanes. Using these sources of flight information, the airline processor 26 generates an updated set of flight information data for all flights operated by the airline 20. Telecommunication connections, data storage devices, input devices and other hardware which may be used by the airline processor 26 in generating airline-specific FID are not shown.

The information contained in the airline-specific FID transmitted by the airline processor 26 may include such data as an identification of the airline 20 operating the airline processor 26, and for each flight, a flight number, departure airport, gate and time, and arrival airport, gate and time. FIG. 3 is a sample data structure for the airline-specific FID generated and transmitted by the airline processor 26. In this embodiment, the airline-specific FID only contains current information, namely flight information for flights which have recently landed, are in the air, or will be departing shortly. Although not shown in FIG. 3, the data structure for the airline-specific FID could include other data, such as an on-time status of a flight.

Transmission of the airline-specific FID from each airline processor 26 to the FIP processor 28 occurs from time to time upon the occurrence of one of several possible triggering events. For example, transmission may take place at regular intervals selected by the airline 20 or by the FIP 22, upon request by the FIP processor 28, or every time the airline processor 26 detects that a change to flight information has taken place. In the present embodiment, airline-specific FID is transmitted by an airline processor 26 to the FIP processor 28 whenever the airline processor 26 detects a change in flight information for that airline has taken place.

The airline-specific FID is transmitted through the first network 21, to which each of the airline processor 26 and FIP processor 28 are connected. In this case, the network is the Internet, though the network could also be a private network. To ensure privacy, well-known encryption and decryption methods are used in transmitting and receiving the airline-specific FID through the Internet. The transmission itself takes place using any of several well-known transmission methods such as FTP (file transfer protocol).

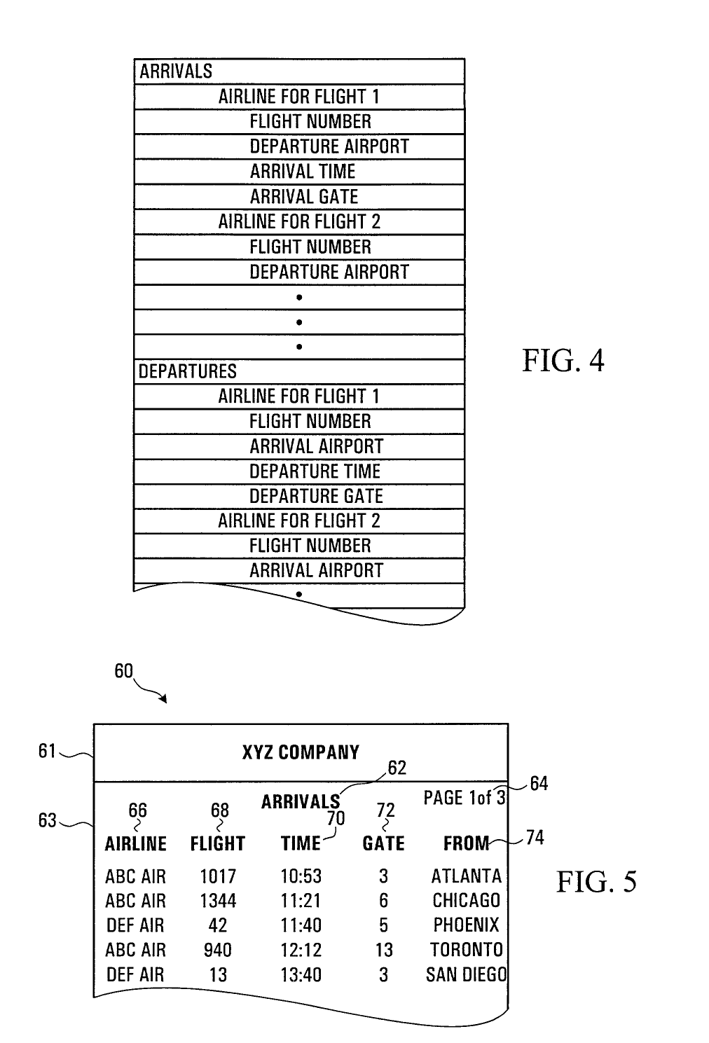

Whenever airline-specific FID is received by the FIP processor 28, the airline-specific FID is filtered by the FIP processor 28 for information relating to specific airports (step 42). In this filtering step, the FIP processor 28 first retrieves a list of subscribing airports stored on the FIP data storage device 30 connected to the FIP processor 28. The list of subscribing airports is generated by the operators of the FIP 22 and stored on the FIP data storage device 30 using an input device such as a keyboard or a mouse (not shown). The airline-specific FID received from each of the airline processors 26 is then filtered such that airport-specific FID is generated for each airport in the list of subscribing airports, containing information for flights operated by the airline, which are relevant to that airport. In this embodiment, a flight is relevant to an airport if the airline-specific FID indicates that the airport is either the departure airport, or the arrival airport for that flight. FIG. 4 is a sample data structure for a set of airport-specific FID for an airport. As is the case in the illustrated data structures, not all information contained in the airline-specific FID for a given flight necessarily need necessarily be included in the airport-specific FID. For example, in the sample data structure of FIG. 4, departure gate and time are excluded for arrivals information in the airport-specific FID, while arrival gate and time are excluded for departures. Additionally, as with the data structure for the airline-specific FID, the data structure for the airport-specific FID could include other data, such as an on-time status of a flight.

The FIP processor 28 then retrieves from the FIP data storage device, any existing web page for any airport 24 for which airport-specific FID was generated in the filtering step 42. Any such existing web pages were generated by the FIP processor 28 in a previous cycle of the method in accordance with the present invention. Using the airport-specific FID for a particular airport, the FIP processor 28 then modifies any existing web page for that airport to delete all references to flights operated by the airline whose processor transmitted the airline-specific FID, and inserting any flight information data contained in the airport-specific FID for that airport. If there is no existing web page for an airport, a web page is generated using the airport-specific FID for that airport. The web pages modified or generated by the FIP processor 28 are then stored on the FIP data storage device 30.

A sample web page 60 is shown in FIG. 5. The sample web page 60 displays at the top of the page, banner advertisement 61 displaying advertisements for an airline, a client, or third-party companies who have paid to have their advertisements displayed on airport monitors 36 as discussed in greater detail below. The web page 60 also contains one or more embedded flight information display pages for display in the lower portion of the page along with instructions to cycle through these flight information display pages on a periodic basis, every 5 seconds for example. FIG. 5 shows a first embedded flight information display page 63 displaying flight information for a first set of flights arriving at an airport. This first embedded flight information display page 63 indicates that it lists arrivals information 62, and that it is page one of three 64 arrivals pages. The first embedded flight information display page 63 then lists for each flight arriving at the airport, the airline 66 operating the flight, the flight number 68, the time of arrival 70, the gate at which the flight will be arriving, and the departure airport 72. Optionally, information for a given flight may blink, alternating between the airline actually operating the flight, and a code share partner of that airline for that flight. Other embedded flight information display pages include further arrivals information as well as departure information. Embedded flight information display pages showing departure information may list for each flight, the airline operating the flight, the flight number, the time of departure, the gate of departure and the airport where the flight will be landing. Of course, the embedded flight information display pages may also communicate other information. For example, flights which are early or have been delayed may appear in a distinctive manner, highlighted in green or red for example. The embedded flight information display pages may also have a status column, indicating whether each flight is on-time, early, delayed or cancelled.

The banner advertisement 61 at the top of the web page 60 may optionally consist of embedded banners for a number of companies in addition to instructions for the banner advertisement 61 to cycle through these embedded banners on a period basis, every 10 seconds for example. Alternatively, a new embedded banner may be displayed each time a new embedded flight information display page is displayed. Of course, other forms of web capable advertising may be displayed instead of, or in addition to the banner advertisements.

Upon request from the airport processor 32 operated by one of the airports 24, the FIP processor retrieves the web page 60 for the airport 24 from the FIP data storage device, and transmits it to the airport processor 32 (step 46). Such transmission takes place through the second network 23 on which both the FIP processor 28 and the airport processor 32 are resident. The second network 23 in this embodiment is the Internet, though in other embodiments it may be a private network. Further, the first network 21 and second network 23 may one in the same, as is the case in the present embodiment, in which both networks 21 and 23 consist of the Internet.

The web page 60 is then processed by a web browser operating on the airport processor 32, which displays the web page 60 on the airport monitors 36 connected to the airport processor 32.

The process is then repeated whenever any of the airline processors 26 transmits updated airline-specific FID to the FIP processor 28.

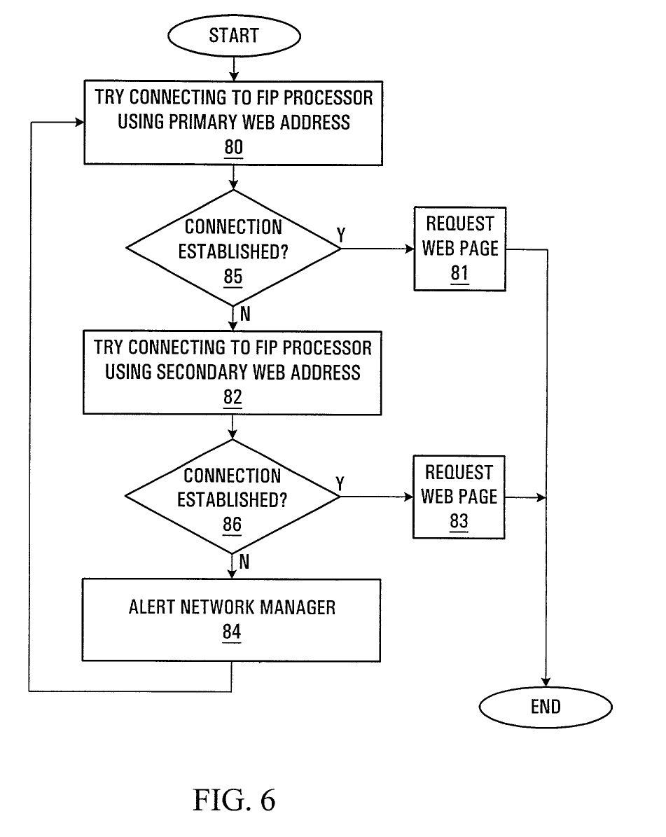

To increase reliability of the system and to ensure that each airport processor 32 will receive updated flight information data as needed, the web browser operating on the airport processor 32 utilizes a redundant access system. In this system, the FIP processor 28 is accessible through a primary web address and a secondary web address. As shown in the flow chart of FIG. 6, the web browser first instructs the airport processor 32 to attempt to connect to the FIP processor 28 through the second network 23 using the primary web address (step 80). If the connection is made, the airport processor 32 is instructed to request the web page 60 for the airport 24 (step 81), and the FIP processor 28 transmits the web page 60 to the airport processor 32 as described above. However, if the airport processor 32 fails to connect to the FIP processor 28 within a first predetermined period of time, 10 seconds for example, the web browser then instructs the airport processor 32 to attempt to connect to the FIP processor 28 through the second network 23 using the secondary web address (step 82). The use of both a primary and a secondary web address significantly reduces the likelihood that the airport processor 32 will be unable to contact the FIP processor 28. If the airport processor 32 again fails to connect to the FIP processor 28 within a second predetermined period of time, 10 seconds for example, the web browser then instructs the airport processor 32 to alert a network manager (step 84). Alerting a network manager can occur by paging the network manager, delivering an email to the network manager, or through other well-known means of communication. The process then reverts to attempting to connect to the FIP processor 28 using the primary web address (step 80). Of course, such a redundant access system for a web browser can be utilized in other applications other than the one specifically described herein.

Although in this embodiment, the web page 60 is described as having multiple embedded display pages for displaying flight information, in addition to instructions to cycle through these embedded display pages, the web page 60 may alternatively contain all flight information with instructions for a web browser displaying the web page 60 to scroll through the information vertically, or to display the information on a number of different pages on a corresponding number of monitors. Additionally, the instructions in the web page 60 may cause the web browser to retrieve new data from the FIP processor 28 without causing an interruption in the display of the web page 60. For example, if the web page 60 contains instructions to cycle through a number of embedded display pages, the airport processor 32 may be instructed to retrieve updated flight information data from the FIP processor 28 just before the end of the cycle, such that updated information will be displayed without interruption to the cycle.

Further, although in FIG. 1, the exemplary computer system network is illustrated as consisting of three airlines and two airports, it is to be understood that the method in accordance with the present invention may be performed on computer system networks having any number of airlines and any number of airports. Furthermore, the method of the present invention may also be practiced with an airline-specific FID collector (not shown) which collects airline-specific FID for some or all of the airlines 20, and the airline-specific FID is received by the FIP processor from the airline-specific FID collector as well as any other airline 20 whose airline-specific FID is not collected by the airline-specific FID collector. Additionally, the first and second networks 21, 23 may be private telecommunication links, or a private network, instead of the public Internet.

In the above description and in the attached figures, the entity to which the FIP 22 transmits the flight information web pages have been described as airports. However, it is to be understood that the flight information web pages may be transmitted to other entities such as subscribing hotels, or individuals, with the airport whose flight information is to be displayed being determined by the geographic location of the entity, or upon selection by the entity.

Additionally, it is to be noted that the present invention also contemplates a host system adapted to execute a client access application directing a host computer to implement the method of the present invention, as well as a computer-readable medium having instructions thereon for implementing the method of the present invention.

Although in this document, phrases such as “flights operated by an airline” have been used, it is to be understood that such flights for a given airline may include those operated by another airline, where the said given airline is a code share partner of the said another airline for that flight.

Numerous modifications and variations of the present invention are possible in light of the above teachings. It is therefore to be understood that within the scope of the appended claims, the invention may be practiced otherwise than as specifically described herein.

1. A method of providing airport-specific flight information data to a client, said method comprising:
collecting from each of a plurality of airlines, airline-specific flight information data for flights operated by the airline, wherein the airline-specific flight information data from at least one of the plurality of airlines includes flight information for flights not departing from or arriving at a particular airport;
identifying in the airline-specific flight information data collected from each of the airlines, airport-specific flight information data consisting of flight information for flights departing from or arriving at the particular airport; and
providing the airport-specific flight information data to the client.

2. The method of claim 1 further comprising receiving a request from the client for airport-specific flight information for the particular airport, and verifying that the client is a subscribing client.

3. The method of claim 1 wherein the client is the particular airport.

4. The method of claim 1 wherein the airport-specific flight information data is provided to the client by generating a web page containing the airport-specific flight information data and transmitting the web page to the client.

5. The method of claim 4 further comprising including in the web page, advertising.

6. The method of claim 5 wherein the client is the particular airport.

7. The method of claim 6 further comprising receiving a request from the client for airport-specific flight information for the particular airport, and verifying that the client is a subscribing client.

8. The method of claim 1 wherein the method is performed by a host computer connectable to each of, a plurality of airline computers each operated by one of the said plurality of airlines, and a client computer operated by the client; the collecting of airline-specific flight information data from each of the plurality of airlines is performed by receiving from each of said plurality of airline computers, the airline-specific flight information data for the airline operating the airline computer; and the provision of the airport-specific flight information data to the client is performed by generating a web page containing the airport-specific flight information data and transmitting the web page to the client computer.

9. The method of claim 8 wherein further comprising including in the web page, advertising.

10. The method of claim 9 wherein the client is the particular airport.

11. A computer-readable medium having stored thereon instructions for implementing the method of claim 8.

12. A host system for collecting, processing and transmitting flight information data, said host system comprising:
a host processor connectable to each of a plurality of airline processors each operated by an airline, and a client processor, said host processor being operable to execute an application causing the host processor to:
collect from each of the airline processors, airline-specific flight information data for flights operated by the airline operating the airline processor, wherein the airline-specific flight information data from at least one of the plurality of airline processors includes flight information for flights not departing from or arriving at a particular airport;
identify in the airline-specific flight information data collected from each of the airline processors, airport-specific flight information data consisting of flight information for flights departing from or arriving at the particular airport; and
transmit the airport-specific flight information data to the client processor.

13. The host system of claim 12 wherein the host processor is caused to transmit the airport-specific flight information data to the client processor is performed by generating a web page containing the airport-specific flight information data and transmitting the web page to the client processor.

14. A method in a client computer of providing reliable access to a host computer, both the client computer and the host computer being connectable to a web-based computer network, said method comprising:
defining a first and a second web address for the host computer;
attempting to access data from the host computer using the first web address; and
upon failure to access data from the host computer using the first web address within a first predetermined period of time, attempting to access data from the host computer using the second web address.

15. The method of claim 14 wherein upon failure to access data from the host computer using the second web address within a second predetermined period of time, alerting a network manager.

16. The method of claim 14 wherein said method is performed by a web browser operating on the client computer.

17. A computer-readable medium having stored thereon instructions for implementing the method of claim 14.

18. A client computer system comprising a client computer operable to implement the method of claim 14.

19. A method in a computer system comprising a processor connected to a monitor, of displaying airport-specific flight information data, said method comprising the steps of:
(a) establishing a network connection with a flight information provider;
(b) requesting from the flight information provider, airport-specific flight information data comprising flight information for flights departing from or arriving at an airport;
(c) receiving from the flight information provider, a web page containing the airport-specific flight information data; and
(d) displaying the web page;
wherein predetermined first and second network addresses are defined for the flight information provider, step (a) is first attempted using the first network address, and if step (a) is not completed within a first predetermined time period, step (a) is attempted using the second network address.

20. The method of claim 19 wherein if step (a) is not completed within a second pre-determined time period using the second network address, alerting a network manager.

21. A computer readable medium having stored thereon instructions for implementing the method of claim 19.

22. A computer system comprising a processor connected to a monitor, said processor being operable to implement the method of claim 19.
